(19) United States
(12) Patent Application Publication
(10) Pub. No.: US 2024/0410406 A1
(43) Pub. Date: Dec. 12, 2024

(54) DEVICE FOR COMPENSATING FOR TOLERANCES BETWEEN TWO COMPONENTS TO BE CONNECTED TO ONE ANOTHER

(71) Applicant: Witte Automotive GmbH, Velbert (DE)

(72) Inventor: Vladimir RADANOVIC, Köln (DE)

(21) Appl. No.: 18/736,631

(22) Filed: Jun. 7, 2024

(30) Foreign Application Priority Data
Jun. 8, 2023 (DE) 10 2023 205 359.4

(51) Int. Cl. F16B 5/06

(52) U.S. Cl. CPC F16B 5/06

(57) ABSTRACT

A device for compensating for tolerances between two components to be connected to one another may have at least one base element and one compensating element, which are at least partially inserted into one another and coupled to one another in a captive manner in an as-delivered state and prior to installation. A connecting element is provided for connecting the two components and is held in a captive and optionally loose manner in the base element or the compensating element in the as-delivered state and prior to installation.

### FIELD

The invention relates to a device for compensating for tolerances between two components to be connected to one another.

### BACKGROUND

Known devices for compensating for tolerances between two components (also known as compensating device for short) are formed by a base element or base body, a metallic threaded sleeve, and an axial compensating element, for example metallic threaded sleeves which are in a threaded engagement, for example a left-hand threaded engagement. A spring element is usually arranged in the axial compensating element and creates a frictional connection between a connecting element that is passed through the compensating device and has a further thread (right-hand thread) and the axial compensating element, so that when the connecting element is tightened, for example rotated, a torque is exerted on the axial compensating element, which causes axial unscrewing of the compensating element from the base element against the insertion direction of the connecting screw and thus compensates for axial tolerances.

The object of the invention is to specify a particularly simply constructed and easy-to-assemble device for compensating for tolerances between two components to be connected to one another.

The object is achieved according to the invention by a device for compensating for tolerances between two components to be connected to one another, according to the appended claims.

### SUMMARY

A first device according to the invention for compensating for tolerances between two components to be connected to one another comprises at least one base element and one compensating element, which are at least partially inserted into one another and coupled to one another in a captive manner, wherein a connecting element is provided for connecting the two components and is held in a captive and optionally loose manner in the base element or in the compensating element in the as-delivered state and prior to installation, in particular final installation.

For example, the compensating element can be formed from two optionally mirror-symmetrical compensating sub-elements, which are configured to form a receiving space when in a connected state, in which receiving space the connecting element is held in a captive and optionally loose manner in the as-delivered state and prior to installation.

A second device according to the invention for compensating for tolerances between two components to be connected to one another comprises at least one base element and one compensating element, which in an as-delivered state and prior to installation are at least partially inserted into one another and coupled to one another in a captive manner, wherein the compensating element is formed from two optionally mirror-symmetrical compensating sub-elements, which are configured to form a receiving space for a connecting element in a connected state.

A third device according to the invention for compensating for tolerances between two components to be connected to one another comprises at least one base element and one compensating element, as well as a connecting element for connecting the two components, wherein one of the two elements, the base element or the compensating element, and the connecting element are arranged relative to one another in such a way that when the connecting element is installed in one of the components, the connecting element can be positioned in a self-centering manner on an inner surface of the base element and/or the compensating element.

All three devices according to the invention shown allow for a pre-installation unit formed from at least the base element and the compensating element, and optionally the connecting element, by means of which they are connected to one another in a captive and detachable manner. With such a pre-installation unit, the device can be pre-installed more quickly and easily in a further pre-installation step on one of the components, and/or installed more quickly and easily and more securely with the two components.

The connecting element is in particular a screw. The connecting element can be designed with or without a screw retention device. For example, the connecting element can be provided with a clamping layer as a screw retention device, for example made of a plastics material, in particular polyamide, and/or an adhesion layer, in particular an adhesive, for example an adhesive integrated into a microencapsulation structure. For example, the screw retention device can be applied in the region of the shaft, in particular a threaded shaft.

The captive arrangement of the connecting element together with the base element and the compensating element also ensures error-free installation. All three devices ensure that no components are mixed up (poka yoke installation). The movable arrangement of the connecting element also makes it easy to compensate for radial tolerances. In particular, the connecting element is pre-installed in the base element and compensating element and held captive in such a way that there is no obstruction or interference during pre-installation of the device on one of the components and/or during final installation of the device with the components. The self-centering of the connecting element takes place without additional elements, and solely through the design of the connecting element and the component of the device—the base element or the compensating element—itself.

In one possible embodiment, the compensating element or the base element has at least one resilient element extending inwards in the radial direction, which holds the connecting element at least in a captive manner in the compensating element in the as-delivered state and prior to installation. For example, the resilient element extends radially from an inner surface of the compensating element or the base element inwards into a cavity in the compensating element or the base element. For example, the resilient element can be resilient in both axial directions. Alternatively, the resilient element can only be resilient in one axial direction and rigid or fixed in the other.

In a further embodiment, the resilient element can be designed as an inner latching lip, in particular as a double rib, in which a head of the connecting element is releasably held. For example, the inner latching lip, in particular the double latching lip, can be designed as a circumferential inner ring, in particular a double inner ring, and can be configured to hold the connecting element centered with respect to the longitudinal axis of the device in a captive manner, in particular to hold it centered and to pre-fix it in a releasable manner.

In a further embodiment, the connecting element has a head and a shaft. The compensating element and/or the base element is/are hollow cylindrical, for example. The compensating element and/or the base element can have two through-openings, for example one through-opening each in the region of their longitudinal ends. For example, the two through-openings can be larger than a diameter of the shaft and smaller than a diameter of the head of the connecting element, so that the connecting element is held in a loose, in particular movable, and captive manner between the two through-openings in the as-delivered state and prior to installation.

In addition, each first through-opening of the compensating element or the base element and/or the resilient element can be designed as a centering device and can be configured to fix the connecting element to the centering device in a self-centering manner when the device is installed. By means of the centering device, the connecting element can be positioned in a self-centering manner when the connecting element is installed in one of the components or in both components.

For example, the centering device can be designed on the inner surface, for example as a centering surface of the compensating element or the base element that tapers radially inwards and in the direction of compensation, for example at an angle. For example, the first through-opening can have a conically tapered centering surface. Alternatively or additionally, the resilient element can be conically tapered.

Furthermore, an opening reducer, for example a washer, can be provided. The opening reducer (also known as a floating opening reducer) can be arranged with radial play in one of the through-openings. The opening reducer is used in particular to reduce the size of one of the through-openings, in particular to ensure the movable and captive arrangement of the connecting element in the device, in particular in the compensating element or in the base element.

In addition, a transport securing means (also known as a retaining means) can be provided between the compensating element and the base element, which comprises at least one resilient retaining element extending in the radial direction on the outside of the compensating element and at least one complementary resilient retaining recess extending in the radial direction on the inside of the base element. Alternatively, the retaining recess can be provided on the compensating element and the resilient retaining element can be provided on the base element. The compensating element and the base element can each also be formed, on one of their longitudinal ends, by means of the transport securing means, to secure the compensating element or the base element in one of the components during transportation and before the final installation of the device. For example, the transport securing means can be formed as a protruding molding, in particular a protruding latching arm or latching hook which projects radially from the outer circumference in some portions.

In a further embodiment, during final installation of the device with the two components, a torque exerted by the connecting element can be transmitted to the compensating element, due to the force engagement, to make it rotate as well. The compensating element can therefore be used to easily compensate for axial component tolerances between the two components.

### DESCRIPTION OF THE FIGURES

Embodiments of the invention are explained in greater detail with reference to the drawings, in which:

FIG. 1 is a schematic perspective view of a device for compensating for tolerances between two components to be connected to one another,

FIG. 2 is a schematic perspective view of the device according to FIG. 1, pre-installed on one of the components,

FIG. 3 is a schematic plan view of the pre-installed device shown in FIG. 2,

FIG. 4 is a schematic side view of the pre-installed device shown in FIG. 2,

FIG. 5 is a schematic side view of a multi-part compensating element with a pre-installed connecting element and without a base element,

FIG. 6 is a schematic plan view of the compensating element with the pre-installed connecting element as shown in FIG. 5,

FIG. 7 is a schematic exploded view from above of the multi-part compensating element and the connecting element,

FIG. 8 is a schematic exploded view from the side of the multi-part compensating element and the connecting element,

FIG. 9 is a schematic exploded view and perspective view of the multi-part compensating element and the connecting element,

FIG. 10 is a schematic sectional view of a compensating element with a centering device for the connecting element,

FIG. 11 is a schematic perspective view of the compensating element with the centering device for the connecting element as shown in FIG. 10,

FIGS. 12 to 14 are schematic views of the sequence of the installation of the device on one of the components,

FIG. 15 is a schematic sectional view of the compensating element with centering device and fixing unit for the connecting element,

FIG. 16 is a schematic, partially cut-away perspective view of the compensating element with the fixing unit for the connecting element,

FIG. 17 is a schematic perspective view of the compensating element with pre-installed connecting element and a positioning unit as an alignment aid during installation, and

FIG. 18 is a further schematic and perspective view of the compensating element with pre-installed connecting element and the positioning unit as shown in FIG. 17.

### DETAILED DESCRIPTION

Parts corresponding to one another are provided with the same reference signs in all the drawings.

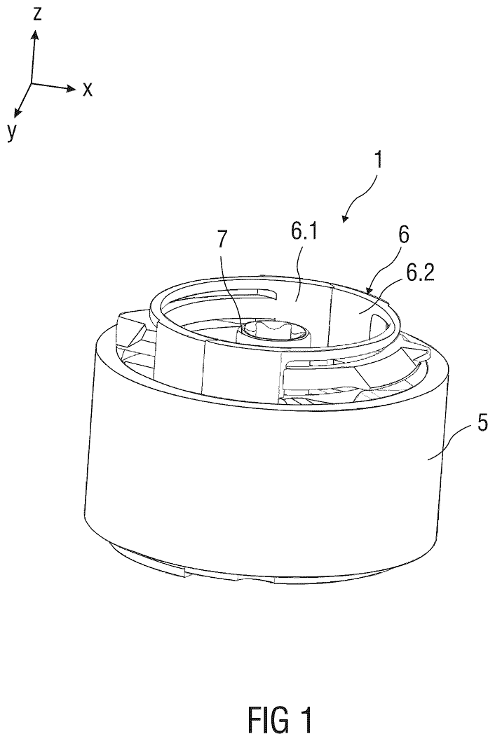

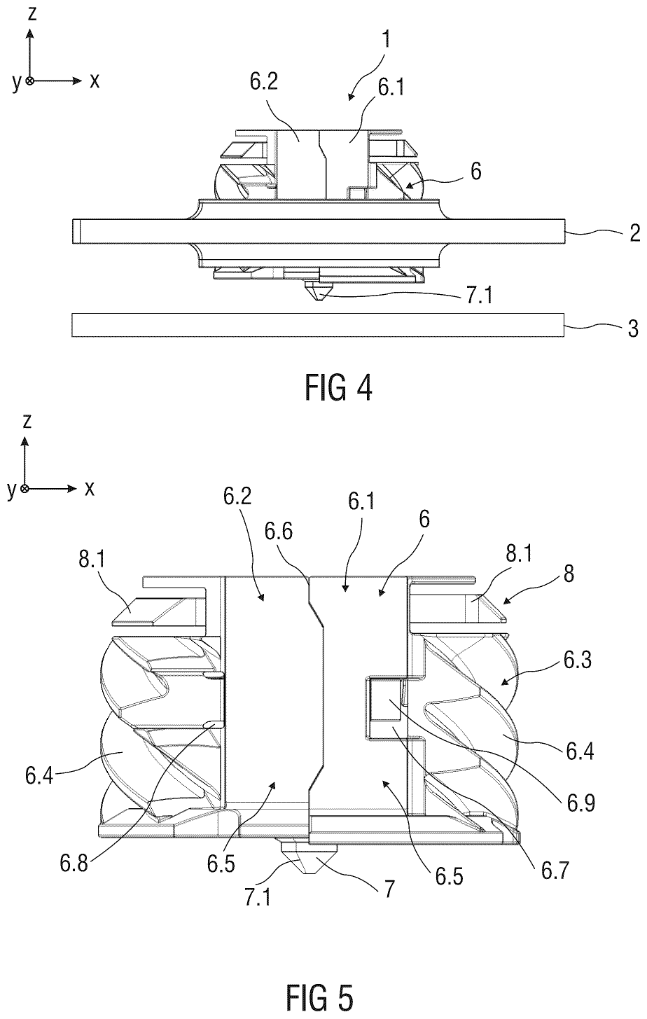

FIG. 1 is a schematic perspective view of a device 1 for compensating for tolerances between two components 2, 3 to be connected to one another (shown in FIG. 4).

The device 1 according to the invention comprises at least one base element 5 and one compensating element 6. The base element 5 is designed as a hollow cylindrical element and in one piece. The compensating element 6 is designed as a hollow cylindrical element and in particular has multiple parts. Preferably, the compensating element 6 is formed from two optionally mirror-symmetrical sub-elements 6.1, 6.2, which can be releasably connected to one another.

In an as-delivered state and prior to installation, in particular final installation, the compensating element 6 and the base element 5 are at least partially inserted into one another and coupled to one another in a captive manner.

In addition, the device 1 comprises a connecting element 7 for connecting the two components 2, 3 by means of the device 1. In the as-delivered state and prior to installation, the connecting element 7 is held in a captive and optionally loose manner in the base element 5 or in the compensating element 6. The invention is described below using the arrangement of the connecting element 7 in the compensating element 6 as an example. Alternatively, the connecting element 7 can be arranged in the base element 5 in a captive and optionally loose manner.

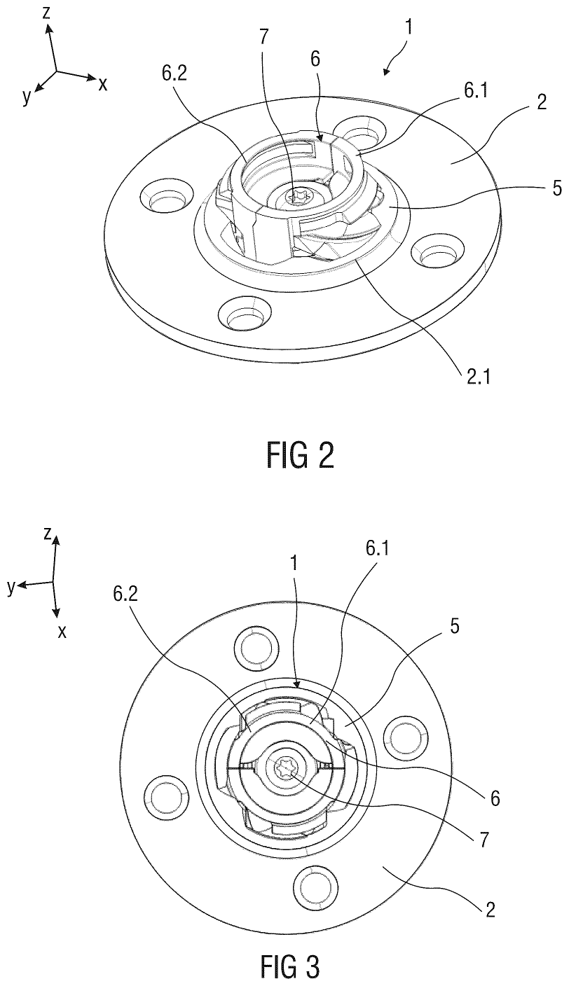

FIG. 2 is a schematic perspective view of the device 1 of FIG. 1, pre-installed on one of the components 2. The base element 5 is arranged with a positive or non-positive connection in a recess 2.1 of the component 2.

In an as-delivered state and prior to installation, the base element 5 and the compensating element 6 are at least partially inserted into one another and coupled to one another in a captive manner.

The compensating element 6 has an external thread 6.3, for example. The base element 5 has, for example, a complementary internal thread (not shown). The base element 5 and the compensating element 6 are inserted into one another and screwed together, at least partially. The connecting element 7 is thus arranged and held in a captive manner in the compensating element 6.

The connecting element 7 is in particular a screw. The connecting element 7 can be designed with or without a screw retention device. For example, the connecting element 7 can be provided with a clamping layer and/or an adhesion layer in some regions to secure the screw. For example, the screw retention device can be applied in certain regions of the shaft, in particular a threaded shaft, of the connecting element 7 (not shown in detail).

FIG. 3 is a schematic plan view of the pre-installed device 1 as shown in FIG. 2.

FIG. 4 is a schematic side view of the device 1 pre-installed on component 2 as shown in FIG. 2 before final installation on component 3. One shaft end 7.1 protrudes from the device 1 in the direction of the component 3 to be installed.

FIG. 5 shows a schematic side view of the multi-part compensating element 6 with the pre-installed connecting element 7 and without the base element 5.

The external thread 6.3 has multiple axial thread portions 6.4, which are interrupted by smooth outer circumferential portions 6.5. The two sub-elements 6.1, 6.2 are adjacent to one another at a dividing line 6.6. The dividing line 6.6 is stepped or curved. In particular, the dividing line 6.6 runs in such a way that the two sub-elements 6.1, 6.2 lie on top of one another in the axial direction and are positioned relative to one another.

In addition, the two sub-elements 6.1, 6.2 have complementary latching means 6.7, 6.8 for releasably connecting the sub-elements 6.1, 6.2. One of the latching means 6.7 is designed, for example, as a latching recess or latching opening. The other latching means 6.8 is designed, for example, as a latching arm with a latching hook 6.9.

The compensating element 6 can also comprise a transport securing means 8 (also known as a retaining means). The transport securing means 8 can be provided between the compensating element 6 and the base element 5 or between the compensating element 6 and one of the components 2 or 3. The transport securing means 8 can, for example, comprise at least one resilient retaining element 8.1 extending in the radial direction on the outside of the compensating element 6 and at least one complementary resilient retaining recess (not shown) extending in the radial direction on the inside of the base element 5 or on the given component 2 or 3.

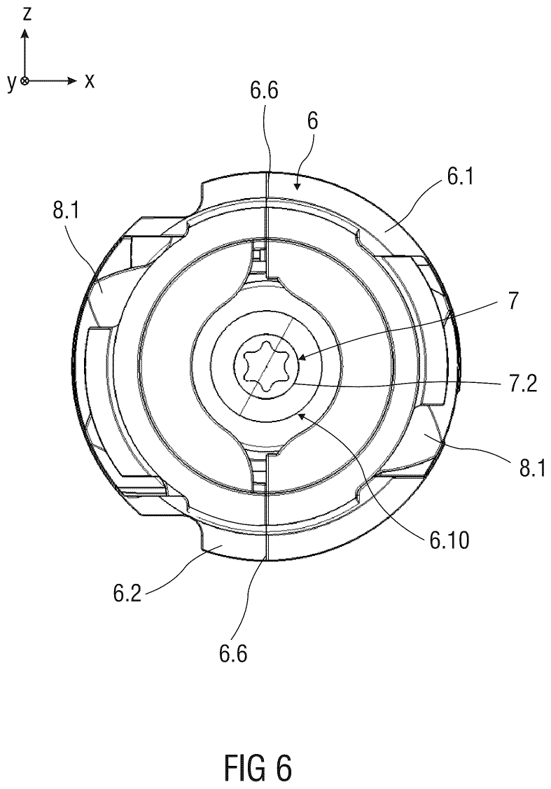

FIG. 6 shows a schematic plan view of the compensating element 6 with the pre-installed connecting element 7 as shown in FIG. 5.

The connecting element 7 has a head 7.2, which is arranged opposite the shaft end 7.1.

The sub-elements 6.1, 6.2 are optionally designed to be mirror-symmetrical and are configured to form a receiving space 6.10 for the connecting element 7 in a connected state. In the receiving space 6.10, the connecting element 7 is held in a captive and optionally loose manner in the as-delivered state and prior to installation.

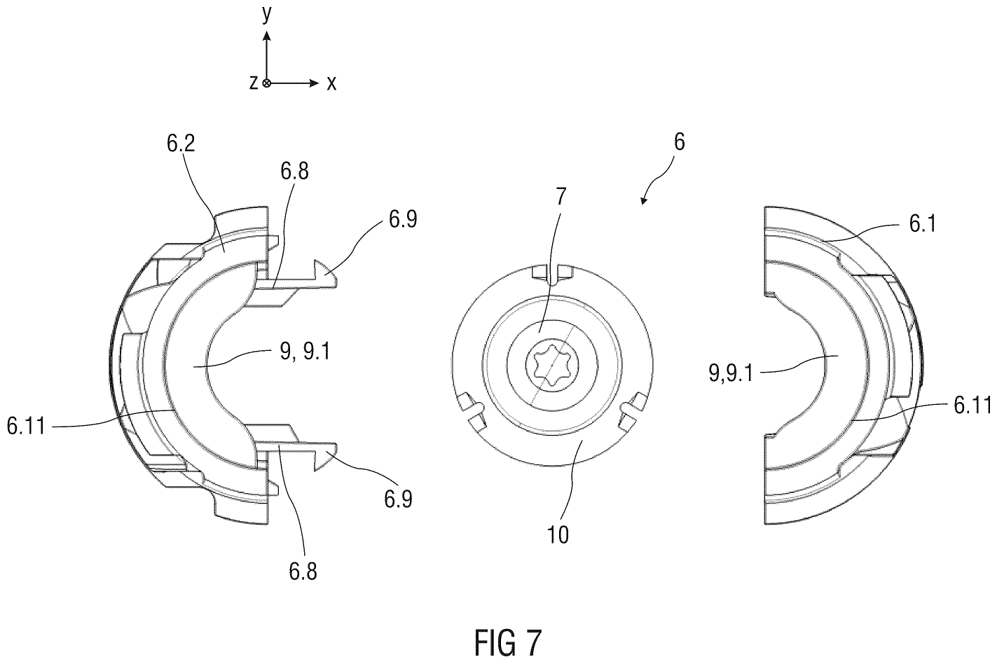

FIG. 7 is an exploded view from above of the multi-part compensating element 6 and the connecting element 7.

When the connecting element 7 is installed in one of the components 2 or 3, the connecting element 7 can be positioned in a self-centering manner on an inner surface 6.11 of the compensating element 6.

For example, a centering device 9 can be provided on the inner surface 6.11 for positioning the connecting element 7 in the device 1 with self-centering. For example, the centering device 9 can be designed as a centering surface 9.1 that tapers radially inwards and in the direction of compensation 100 of the compensating element 6, for example at an angle.

In addition, the device 1 can comprise an opening reducer 10, for example a washer.

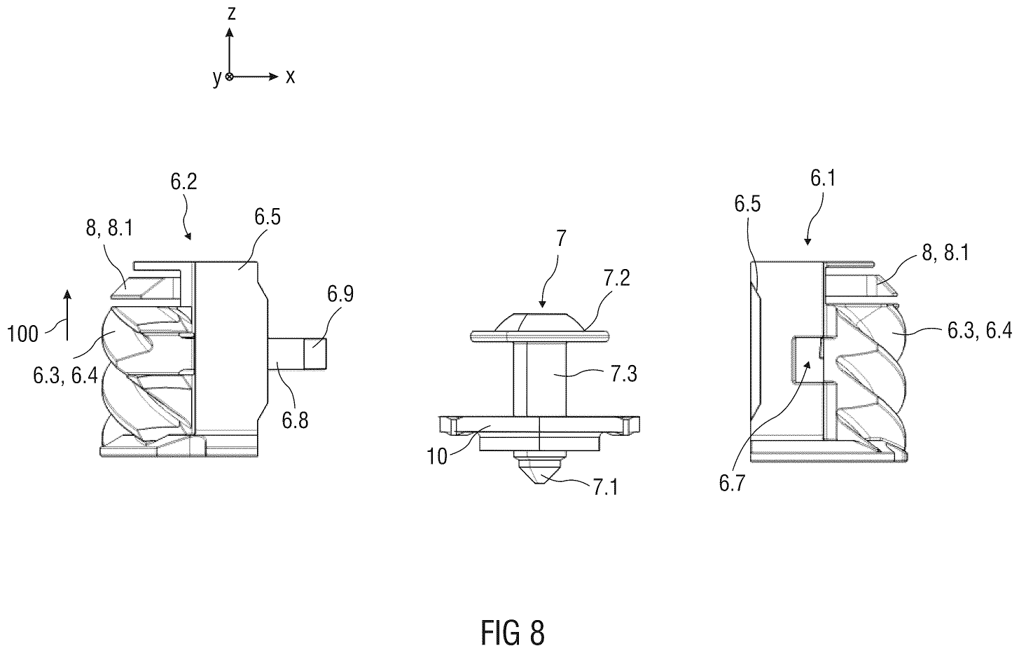

FIG. 8 is an exploded view of the multi-part compensating element 6 and the connecting element 7. The head 7.2 has a larger diameter than a shaft 7.3 of the connecting element 7. The shaft end 7.1 is pointed or V-shaped.

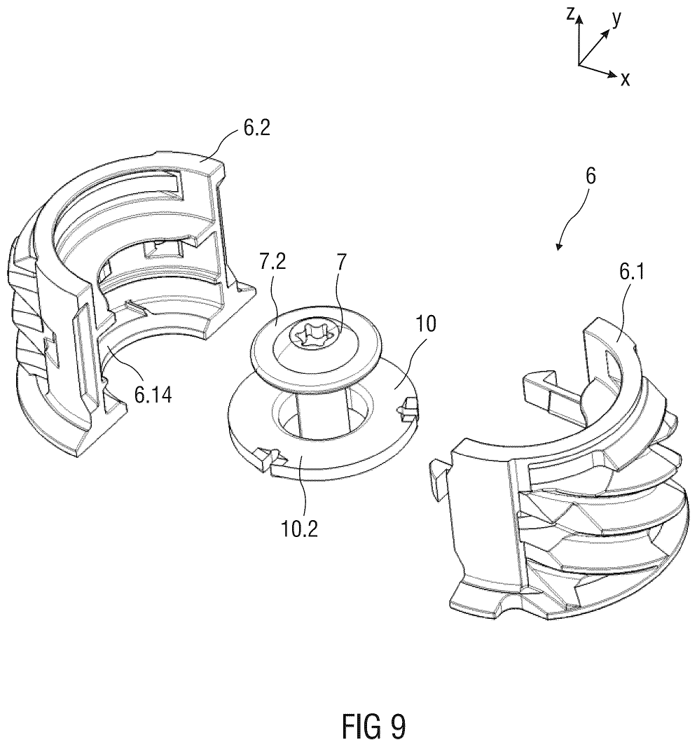

FIG. 9 is a schematic exploded view and perspective view of the multi-part compensating element 6 with the optionally mirror-symmetrical sub-elements 6.1, 6.2 and the connecting element 7, as well as the opening reducer 10, pre-installed on the connecting element 7.

To produce the device 1 as a pre-installation unit, the connecting element 7 and the opening reducer 10 are fixed to one of the sub-elements 6.2, in particular to an abutment 6.14, by means of their retaining flanges 7.4 and 10.2 respectively. The other sub-element 6.1 is then inserted into sub-element 6.2. The two sub-elements 6.1, 6.2 are releasably connected to one another, in particular latched or clipped together, by means of the latching means 6.7, 6.8.

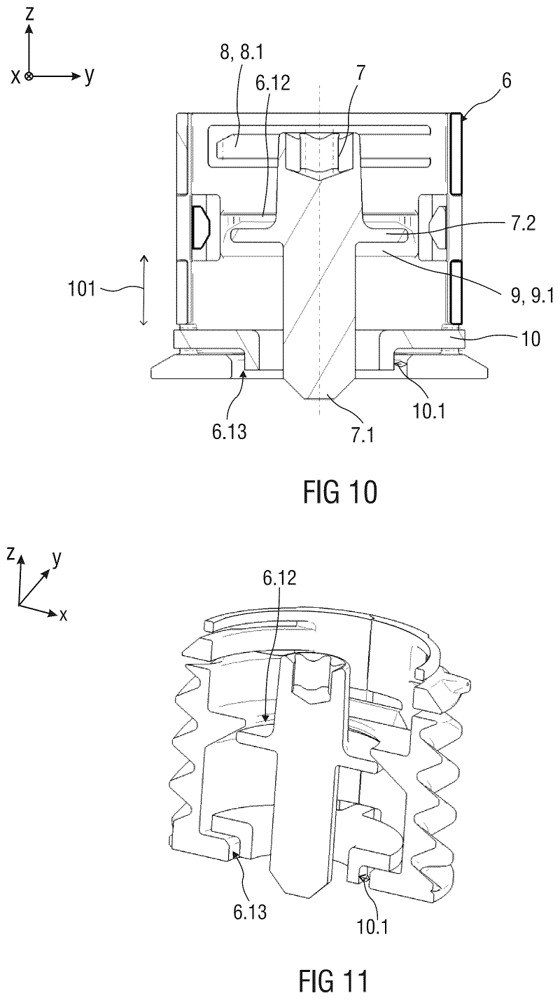

FIG. 10 shows a schematic sectional view of the compensating element 6 with the centering device 9 and the radially inwardly projecting centering surface 9.1 for the connecting element 7.

The compensating element 6 can have two through-openings 6.12, 6.13. For example, the two through-openings 6.12, 6.13 can be larger than a diameter of the shaft 7.3 and smaller than a diameter of the head 7.2 of the connecting element 7, so that the connecting element 7 is held in a loose, in particular movable manner according to arrow 101, and in a captive manner, between the two through-openings 6.12, 6.13 in the as-delivered state and prior to installation.

In the event that one of the through-openings 6.13 is larger than the head 7.2, the opening reducer 10 can be arranged in this through-opening 6.13. The opening reducer 10 can be formed as a floating opening reducer 10. In particular, the opening reducer 10 is arranged with radial play 10.1 in the through-opening 6.13.

The opening reducer 10 is held captive by positive locking. The opening reducer 10 can have a radial play 10.1 in a range of −/+1 mm, for example. The connecting element 7 can compensate for radial play in the opening reducer 10 of +/−2 mm, for example.

In addition, the opening reducer 10, in particular a washer, can serve as a compression limiter that limits the flow of force in the plastics material, thereby limiting or preventing undesired relaxation of the plastics material.

The device 1 can be made of different materials or the same material. The base element 5 and the compensating element 6 and optionally the opening reducer 10 can be made of plastics material, for example. The connecting element 7 can be made of metal or plastics material.

FIG. 11 is a schematic sectional perspective view of the compensating element 6 with the centering device 9 for the connecting element 7 as shown in FIG. 10.

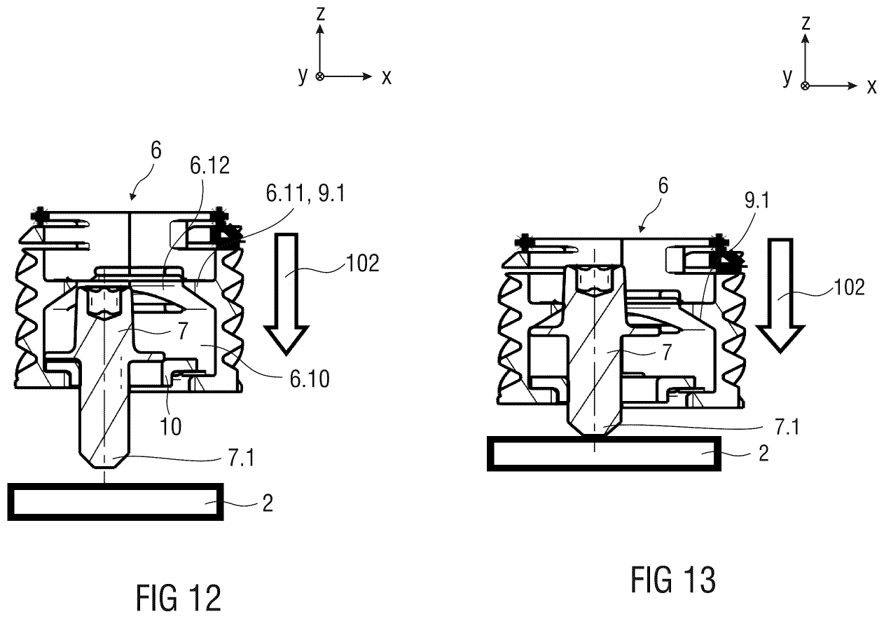

FIGS. 12 to 14 are schematic views of a sequence of the installation of the device 1 on one of the components 2, whereby only the compensating element 6 and the connecting element 7 as well as the opening reducer 10 are shown for better clarity.

As shown in FIG. 12, the compensating element 6 is supplied with the pre-installed connecting element 7, for example a screw, and the pre-installed opening reducer 10. Not shown is the base element 5 (as shown in FIG. 1), which is arranged captively on the compensating element 6.

The connecting element 7 is loose and therefore movable in the receiving space 6.10 of the compensating element 6. The connecting element 7 is arranged (in particular its geometric contours and dimensions) in such a way that it is arranged in a captive manner in the receiving space 6.10.

During installation, the compensating element 6 is positioned relative to the installation component 2 by means of the shaft end 7.1 protruding from the compensating element 6 and placed on the latter, in accordance with arrow 102. In the process, the connecting element 7 is drawn into the receiving space 6.10 during connection to the component 2, in particular during screwing, in a self-centering manner relative to the through-opening 6.12, as shown in the sequence of FIGS. 12 to 14.

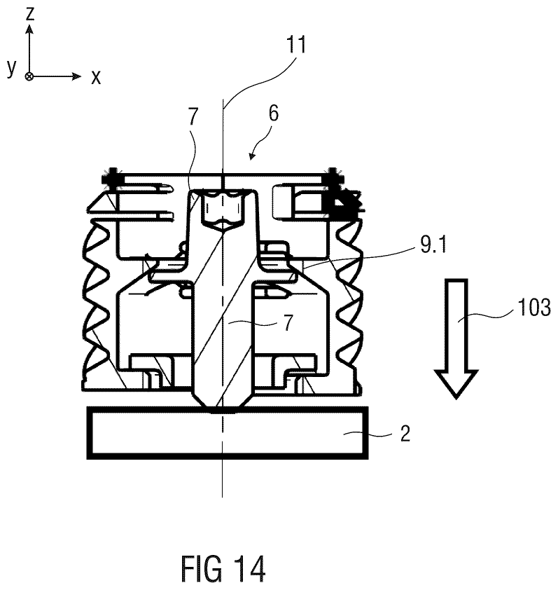

In particular, the connecting element 7 is fixed to the centering device 9, in particular its centering surface 9.1, in a self-centering manner, and centered with respect to the rotation axis 11, as shown in FIG. 14.

The centering surface 9.1 is designed as a conically tapered rib. By means of the inclined centering surface 9.1, the connecting element 7 is brought into a nominal position centered with respect to the rotation axis 11 of the device 1, making it easier to drive it with a tool. After tolerance compensation and upon reaching an end position of the device 1, the connecting element 7, in particular the screw, can be moved out of the nominal position, in particular screwed in the direction of the component 2, by means of axial force according to arrow 103, which is generated, for example, by means of a tool or an installation process.

Due to the loose arrangement of the connecting element 7 in the device 1 on delivery, the connecting element 7 does not interfere during installation; in particular, clamping or obstruction of any kind is reduced or even avoided.

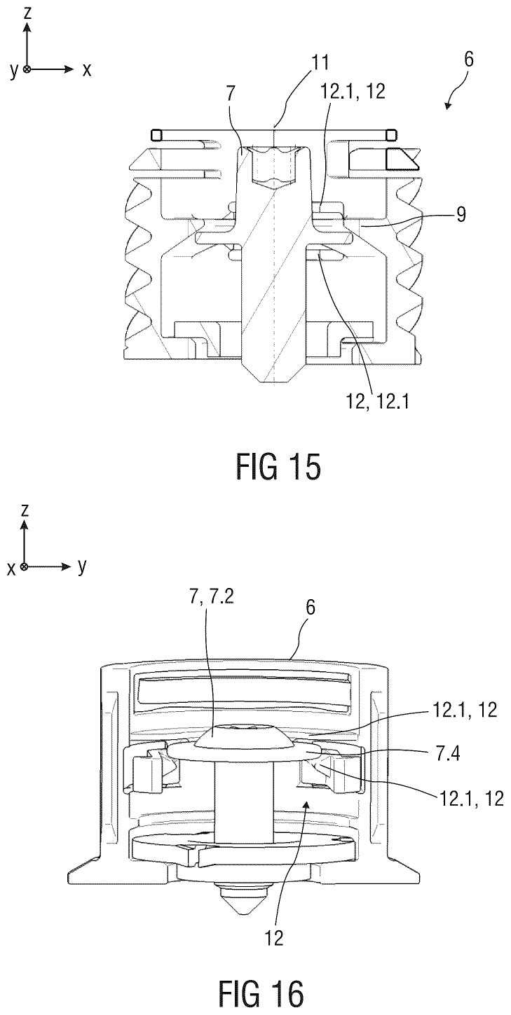

FIG. 15 shows a schematic sectional view of the compensating element 6 with the centering device 9, and a fixing unit 12 for fixing the connecting element 7 in the as-delivered state.

The fixing unit 12 has, for example, at least one resilient element 12.1 extending inwards in the radial direction, which holds the connecting element 7 at least in a captive manner in the compensating element 6 in the as-delivered state and prior to installation. The resilient element 12.1 extends, for example, radially from the inner surface 6.11 of the compensating element 6 inwards into a cavity, in particular the receiving space 6.10, of the compensating element 6. For example, the resilient element 12.1 can be resilient in both axial directions. Alternatively, the resilient element 12.1 can only be resilient in one axial direction and rigid or fixed in the other.

FIG. 16 shows a schematic, partially cut-away perspective view of the compensating element 6 with the fixing unit 12 for the connecting element 7.

In a further embodiment, the resilient element 12.1 can be designed as an inner latching lip, in particular as a double rib, in which the head 7.2, in particular a retaining flange 7.4, of the connecting element 7 is releasably held. For example, the inner latching lip, in particular the double latching lip, can be designed as a circumferential inner ring, in particular a double inner ring, and can be configured to hold the connecting element 7 centered with respect to the longitudinal axis or rotation axis 11 (shown in FIG. 15) of the device 1 in a captive manner, in particular to hold it centered and to pre-fix it in a releasable manner.

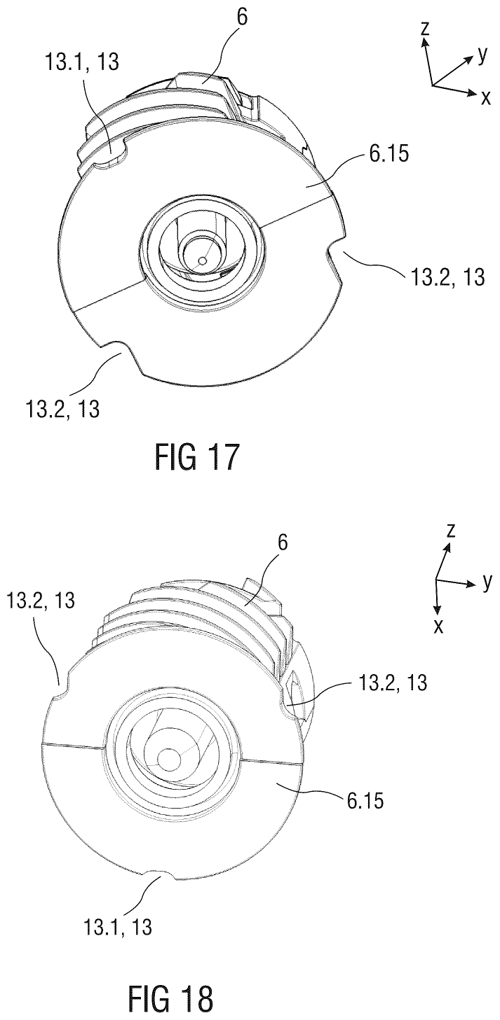

FIG. 17 shows a schematic perspective view of the compensating element 6 with pre-installed connecting element 7 and a positioning unit 13 as an alignment aid during installation. The positioning unit 13 is formed on a contact flange 6.15.

To enable correct positioning in the installation system, the compensating element 6 has at least two different recesses 13.1, 13.2 as positioning units 13. This means that installation is only possible in the corresponding provided interfaces of the components 2, 3. During installation, the recesses 13.1, 13.2 (also known as poka-yoke recesses) can also be used for positioning in an installation system.

FIG. 18 shows a schematic perspective view of the compensating element 6 with pre-installed connecting element 7 and the positioning unit 13 as shown in FIG. 17.

### LIST OF REFERENCE SIGNS

1 Device
2 Component
2.1 Recess
3 Component
5 Base element
6 Compensating element
6.1 Sub-element
6.2 Sub-element
6.3 External thread
6.4 Thread portion
6.5 Outer circumferential portion
6.6 Dividing line
6.7 Latching means
6.8 Latching means
6.9 Latching hook
6.10 Receiving space
6.11 Inner surface
6.12 Through-opening
6.13 Through-opening
6.14 Abutment
6.15 Contact flange
7 Connecting element
7.1 Shaft end
7.2 Head
7.3 Shaft
7.4 Retaining flange
8 Transport securing means
8.1 Retaining element
9 Centering device
9.1 Centering surface
10 Opening reducer
10.1 Radial play
10.2 Retaining flange
11 Rotation axis
12 Fixing unit
12.1 Resilient element
13 Positioning unit
13.1 Recess
13.2 Recess
100 Direction of compensation
101 Arrow
102 Arrow
103 Arrow

What is claimed is:

1. A device for compensating for tolerances between two components to be connected to one another, the device comprising at least one base element and one compensating element, which are at least partially inserted into one another and coupled to one another in a captive manner in an as-delivered state and prior to installation,
wherein a connecting element is provided for connecting the two components and is held in the base element or the compensating element in a captive and loose manner in the as-delivered state and prior to installation.

2. A device for compensating for tolerances between two components to be connected to one another, wherein the device comprises at least one base element and one compensating element, as well as a connecting element for connecting the two components, wherein one of the two elements, the base element or the compensating element, and the connecting element are arranged relative to one another in such a way that, when the connecting element is installed in one of the components, the connecting element can be positioned in a self-centering manner on an inner surface of the base element and/or of the compensating element, wherein the compensating element or the base element is formed from two sub-elements which are configured to form a receiving space when connected to one another, in which receiving space the connecting element is held in a captive and loose manner in the as-delivered state and prior to installation.

3. The device according to claim 1,
wherein the compensating element or the base element is formed from two sub-elements which are configured to form a receiving space when connected to one another, in which receiving space the connecting element is held in a captive and optionally loose manner in the as-delivered state and prior to installation.

4. A device for compensating for tolerances between two components to be connected to one another, wherein the device comprises at least one base element and one compensating element, which in an as-delivered state and prior to installation are at least partially inserted into one another and coupled to one another in a captive manner, and wherein the compensating element or the base element is formed from two sub-elements which are configured to form a receiving space for a connecting element when connected to one another, the compensating element or the base element having at least one resilient element extending inwards in the radial direction, which holds the connecting element at least in a captive manner in the compensating element or in the base element in the as-delivered state and prior to installation, the resilient element being designed as an inner latching lip in which the connecting element is releasably held,
wherein the inner latching lip is designed as a circumferential inner ring and is configured to hold the connecting element centered with respect to the longitudinal axis or rotation axis of the device in a captive manner.

5. The device according to claim 1,
wherein the compensating element or the base element has at least one resilient element extending inwards in the radial direction, which holds the connecting element at least in a captive manner in the compensating element or in the base element in the as-delivered state and prior to installation.

6. The device according to claim 5,
wherein the resilient element is designed as an inner latching lip in which the connecting element is releasably held.

7. The device according to claim 6,
wherein the inner latching lip is designed as a circumferential inner ring and is configured to hold the connecting element centered with respect to the longitudinal axis or rotation axis of the device in a captive manner.

8. The device according to claim 1,
wherein the connecting element has a head and a shaft and the compensating element and/or the base element has/have at least two through-openings which are larger than a diameter of the shaft and smaller than a diameter of the head, so that the connecting element is held in a loose and captive manner between the two through-openings in the as-delivered state and prior to installation.

9. The device according to claim 8,
wherein one of the through-openings of the compensating element or of the base element and/or the resilient element is/are designed in each case as a centering device and is/are configured to fix the connecting element to the centering device in a self-centering manner when the device is installed.

10. The device according to claim 9,
wherein the centering device is formed on the inner surface of the compensating element or of the base element, wherein the inner surface tapers radially inwards and conically in the direction of compensation.

11. The device according to claim 9,
wherein an opening reducer is arranged in at least one of the through-openings.

12. The device according to claim 11,
wherein the opening reducer is arranged with a radial play in one of the through-openings.

13. The device according to claim 2,
wherein a transport securing means is provided between the compensating element and the base element or between the compensating element and one of the components, which comprises at least one resilient retaining element extending in the radial direction on the outside of the compensating element and at least one complementary resilient retaining recess extending in the radial direction on the inside of the base element.

14. The device according to claim 2,
wherein the sub-elements are formed to be mirror-symmetrical to one another.
